(19) United States
(12) Patent Application Publication
(10) Pub. No.: US 2002/0156621 A1
(43) Pub. Date: Oct. 24, 2002

(54) Parametric coding of an audio or speech signal

(76) Inventor: Albertus Cornelis Den Brinker, Eindhoven (NL)

Correspondence Address: Philips Electronics North America Corporation, 580 White Plains Road, Tarrytown, NY, 10591, US

(21) Appl. No.: 10/046,472

(22) Filed: Jan. 14, 2002

(30) Foreign Application Priority Data
Jan. 16, 2001 (EP) 01200142.6
Jul. 6, 2001 (EP) 01202612.6

(51) Int. Cl. G10L 19/08

(52) U.S. Cl. 704/220

(57) ABSTRACT

A known encoder 100 comprises a segmentation unit 110 for segmenting an audio or speech signal s into at least one segment x(n) and a calculation unit 120 for calculating sinusoidal code data in the form of frequency and amplitude data of a given extension \hat{x}(n) from the segment x(n) such that the extension \hat{x}(n) approximates the segment x(n) as good as possible for a given criterion. It is the object of the invention to improve the known encoder such that the calculation of said sinusoidal code data can be carried out in a simpler and cheaper way. This object is solved according to the invention by calculating the sinusoidal code data θₖ^{l} , dⱼ^{l} and eⱼ^{l} for the segment x(n) according to the following extension \hat{x}:

$${x}^{⋒} = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ] . \qquad Fig . 1.$$

The invention relates to a parametric encoder and method for encoding an audio or speech signal into sinusoidal code data according to the preambles of claims 1 and 6, respectively.

The invention further relates to a parametric decoder and method for re-constructing an approximation of said audio or speech signal from said sinusoidal code data according to the preambles of claims 11 and 12, respectively.

Audio and speech signals are preferably encoded before being transmitted via a channel or stored on a storage medium in order to compress the data of said signals. Audio or speech signals are substantially represented by sinusoidal code data and consequently specific encoders are known in the art specialised for the encoding of these signals. Such a parametric encoder is e.g. known from E. B. George and M. J. T. Smith, “A new speech coding model based on a least-squares sinusoidal representation”. In Proc. 1987 Int. Conf. Acoust. Speech Signal Process. (ICASSP87), pages 1641-1644, Dallas Tex., 6-9 April 1987. IEEE, Picataway, N.J. The parametric encoder described there is illustrated in FIG. 5. According to FIG. 5 the parametric encoder 500 comprises a segmentation unit 510 for segmenting a received audio or speech signal s into at least one finite segment x(n).

Said segment x(n) is input to a calculation unit 520. Said calculation unit 520 calculates sinusoidal code data in the form of phase and amplitude data of a given extension \hat{x} from the segment x(n) such that the extension \hat{x} approximates the segment x(n) as good as possible for a given criterion, e.g. minimum of weighted squared error. For the cited parametric encoder the extension is given by

$$\begin{matrix}{x}^{⋒} ( n ) = {\sum }_{i = 1}^{L} {A}^{i} ( n ) cos ( {Φ}^{i} ( n ) ) \\ with & ( 1 ) \\ {A}^{i} ( n ) = {\sum }_{j = 0}^{J - 1} {a}_{j}^{i} {n}^{j} & ( 2 )\end{matrix}$$

$${Φ}^{i} ( n ) = {\sum }_{k = 0}^{K - 1} {φ}_{k}^{i} {n}^{k} \qquad ( 3 )$$

with a_{J}^{l} and φₖ^{l} are polynomial coefficients of the amplitude parameter Aⁱ and of the phase parameter φ^{l}.

The calculation unit 520 comprises a frequency estimation unit 522 for calculation the phase coefficients φₖ^{l} from the received segment x(n) for example, for k=1 (thus φ₁^{l}), by picking frequencies in the frequency spectrum of said segment x(n). These phase coefficients φₖ^{l} represent the phase part of said sinusoidal code data are on one hand output to a multiplexer 530 and are on the other hand input into a pattern generation unit 524. Said pattern generation unit serves for calculating the phase parameter Φⁱ(n) according to equation (3).

The pattern generation unit 524 further generates a plurality of J×L components pᵢⱼ of the extension \hat{x}(n) according to

pᵢⱼ(n)=n^{j} cos (Φⁱ)(n)), with i=1−L,j=0−(J−1)

The plurality of J×L components pᵢⱼ is input to an amplitude estimation unit 526 which determines the optimal amplitude data a_{J}^{l} from said received components as well as from the received segment x(n) output from the segmentation unit 510.

The phase coefficients φₖ^{l} and the amplitudes a_{J}^{l} form the sinusoidal code data which represents the extension \hat{x}(n) as an approximation of the segment x(n). These sinusoidal code data are multiplexed by the multiplexer 530 in order to form a data stream which may be stored on a recording medium or transmitted via a channel.

The extension \hat{x}(n) as described by equation 1 and as known from the described parametric encoder 500 provides a proper approximation for an individual segments x(n) of the audio or speech signal. However, the calculation of the sinusoidal code data is rather complicated.

Starting from that prior art it is an object of the invention to improve a known parametric encoder and method for encoding an audio or speech signal into sinusoidal code data and to improve a known parametric decoder and method for re-constructing an approximation of said audio or speech signal from said sinusoidal code data after transmission or restoration such that the calculation of said sinusoidal code data can be carried out in a simpler and cheaper way.

This object is solved by the subject matter of claim 1. More specifically, this object is solved by adapting the calculation unit to calculate the sinusoidal code data θₖ^{l}, d_{J}^{l} and e_{J}^{l} for the following extension \hat{x}:

$$\begin{matrix}{x}^{⋒} ( n ) = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ] \\ with \\ {Θ}^{i} ( n ) = {\sum }_{k = 1}^{K} {θ}_{k}^{i} {n}^{k}\end{matrix}$$

wherein:

| | |
|---|---|
| i | represents a component of the extension \hat{x} (n); |
| j,k | represent parameters; |
| n | represents a discrete time parameter; |
| θₖⁱ | represents the phase coefficient value as one of said sinusoidal |
| | code data |
| fⱼ | represents the jth instance out of the set of J linearly |
| | independent fuctions; |
| Θⁱ | is a phase; and |
| dⱼⁱ, eⱼⁱ | represent the linearly involved amplitude values of the |
| | components representing the amplitude parts of said |
| | sinusoidal code data. |

Advantageously, the optimisation problem occurring when trying to define the sinusoidal data such that the claimed extension \hat{x} accurately describes a specific segment x(n) is easy to solve. The easy calculation results from the fact that except the phase coefficients θₖ^{l} the amplitude data d_{J}^{l} and e_{J}^{l} are linearly involved within the claimed extension \hat{x}. Note that there does not appear a zeroth order phase coefficient in Θ^{l}, whereas such component exists in Φ^{l} in the form of φ₀^{l}.

Further, advantageously the claimed extension \hat{x} provides more degrees of freedom for defining the sinusoidal code data with the result, that the claimed extension \hat{x} is broader than the extensions known in the art and provides a more accurate approximation of an individual segment x(n).

According to a first embodiment of the invention the linearly independent function fⱼ(n) is set to fⱼ(n)=n^{j}. In that way the claimed extension \hat{x} is restricted to a polynomial extension.

Further advantageous embodiments of the claimed parametric encoder and in particular of the claimed calculation unit are subject matter of the dependent encoder claims.

The above identified object is further solved by a method for encoding an audio or speech signal as claimed in claim 6. The advantages and embodiments of the said method correspond to the advantages and embodiments as explained above for the parametric encoder.

The above identified object is further solved by a parametric decoder for re-constructing an approximation \hat{x} of an audio or speech signal from transmitted or restored code data according to claim 11. More specifically, the object is solved by adapting a known synthesiser to re-construct said segments \hat{x} from said sinusoidal code data φₖ^{l}, d_{J}^{l} and e_{J}^{l} according to the following formula:

$$\begin{matrix}{x}^{⋒} ( n ) = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ] \\ with \\ {Θ}^{i} ( n ) = {\sum }_{k = 1}^{K} {θ}_{k}^{i} {n}^{k}\end{matrix}$$

wherein:

| | |
|---|---|
| i | represents a component of the extension \hat{x} (n); |
| j,k | represent parameters; |
| n | represents a discrete time parameter; |
| fⱼ | represents the jth instance out of the set of J linearly |
| | independent functions; |
| θₖⁱ | represents the phase coefficient as one of said sinusoidal data |
| Θⁱ | is a phase parameter; and |
| dⱼⁱ, eⱼ^{i:} | represent the linearly involved amplitude values of the |
| | components representing parts of said sinusoidal data. |

Advantageously, the calculation of the claimed extension \hat{x} is easier than the calculation of the extensions known in the art. This is due to the linear involvement of the amplitude data d_{J}^{l} and e_{J}^{l} within said extension and the omission of the zeroth-order phase coefficient.

Due to the easy calculation of the extension \hat{x} the reconstruction of the original audio or speech signal s in the form of its approximation \hat{x} can be realised cheaper and quicker.

The above identified object is further solved by the decoding method as claimed by claim 12. The advantages of said method correspond to the advantages mentioned above by referring to the parametric decoder.

Five figures are accompanying the description, wherein

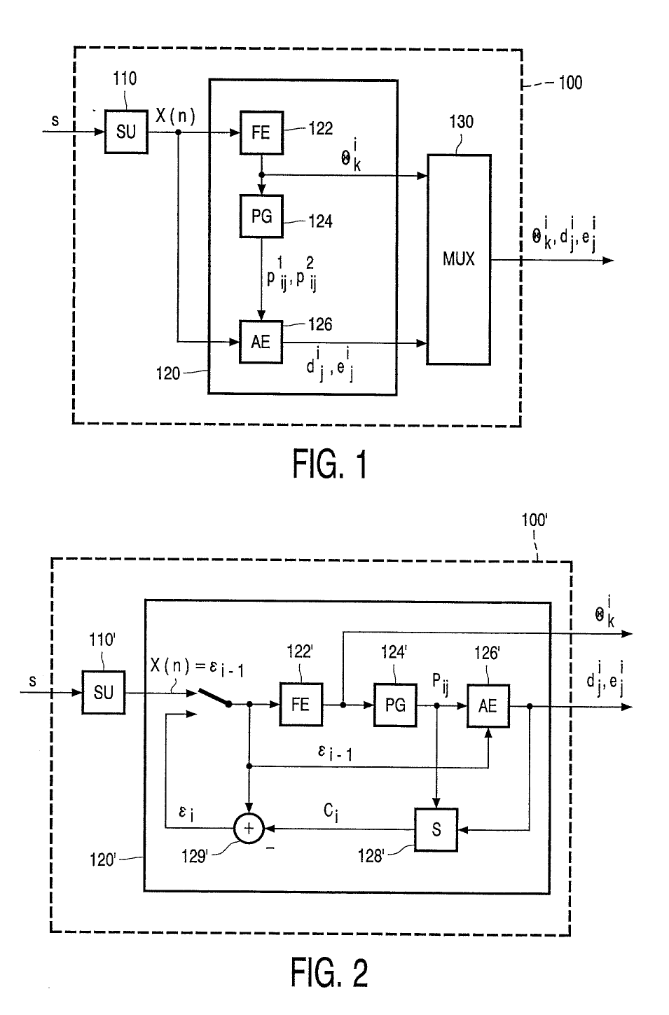

FIG. 1 shows a first embodiment of the parametric encoder according to the invention;

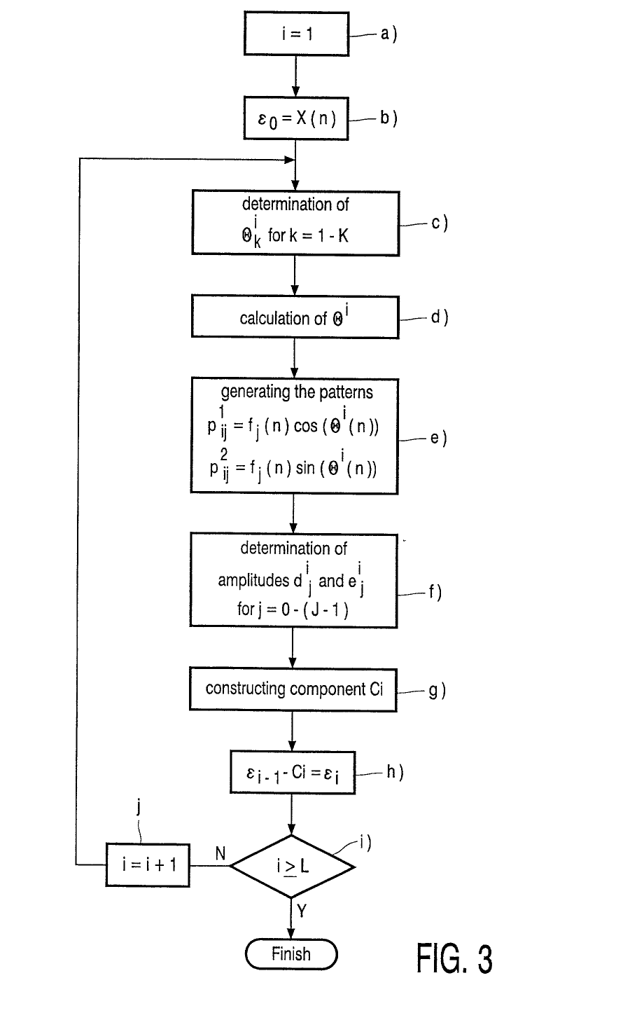

FIG. 2 shows a second embodiment of the parametric encoder according to the invention;

FIG. 3 shows a flow chart illustrating the operation of the second embodiment of the parametric encoder according to the invention;

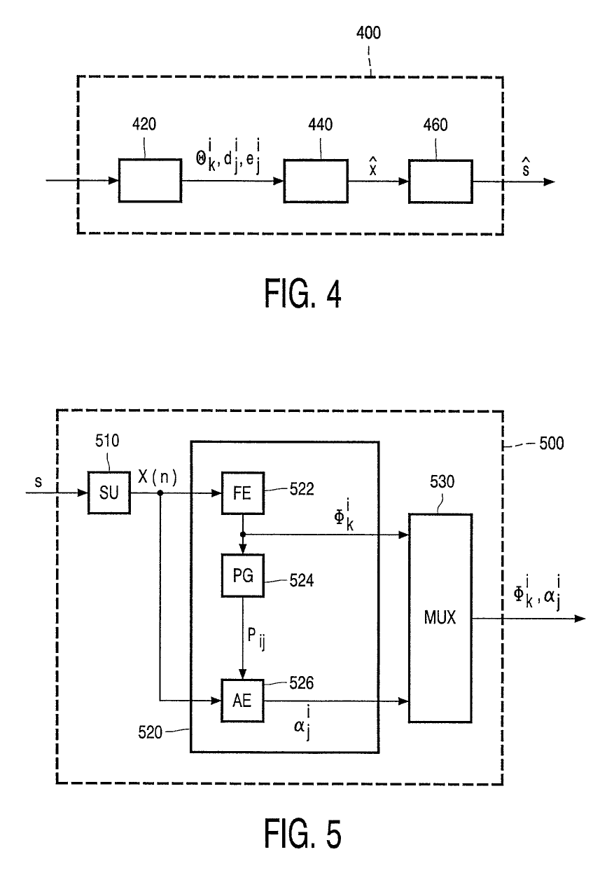

FIG. 4 shows a parametric decoder according to an embodiment of the invention; and

FIG. 5 shows a parametric encoder as known in the art.

Before describing the preferred embodiments of the invention some basic explanations about the subject matter of the invention are given.

The invention proposes an extension \hat{x}(n) for approximating a segment x(n) of a sinusoidal audio or speech signal s. Said extension \hat{x}(n) is represented by phase and amplitude data, hereinafter also referred to as sinusoidal code data. The sinusoidal code data is defined such that the extension \hat{x}(n) approximates the segment x(n) of the audio or speech signal as good as possible for a given criterion, e.g. minimisation of the squared weighted error. Expressed in other words, the sinusoidal code data has to be defined by solving an optimisation problem. After the sinusoidal code data has been defined for optimally approximating a particular segment x(n) it might be stored on a storage medium or transmitted via a channel as code data representing said segment x(n) and thus also representing said audio or speech signal s. Preferably, before being stored or transmitted the sinusoidal code data might be encoded and/or cleaned in the way that irrelevant or redundant data is removed from it.

The generation of said sinusoidal code data according to a first embodiment is now explained by referring to FIG. 1.

FIG. 1 shows a first preferred embodiment of a parametric encoder 100 for generating said sinusoidal code data representing an input audio or speech signal s. The received signal s is input to a segmentation unit 110 for segmenting said signal s into at least one segment x(n). Said segment x(n) is input into a calculation unit 120 for generating said sinusoidal code data such that the extension \hat{x} with

$$\begin{matrix}{x}^{⋒} ( n ) = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ] \\ with & ( 4 ) \\ {Θ}^{i} ( n ) = {\sum }_{k = 1}^{K} {θ}_{k}^{i} {n}^{k} & ( 5 )\end{matrix}$$

and wherein:

| | |
|---|---|
| i,j,k | represent parameters; |
| n | represents a discrete time parameter; |
| θₖⁱ | represents the phase coefficient as one of said sinusoidal data |
| fⱼ | represents the jth instance out of the set of J linearly |
| | independent functions; |
| Θⁱ | is a phase; and |
| dⱼⁱ,eⱼⁱ | represent the linearly involved amplitude values of the |
| | components representing parts of said sinusoidal data |

approximates the segment x(n) input to said calculation unit 120 as good as possible for a given criterion, e.g. minimisation of weighted squared error. The sinusoidal code data to be determined by said calculation unit 120 is the phase θₖ^{l} and the amplitude data d_{J}^{l} and e_{J}^{l}.

The term Cᵢ of equation (4) with

$$Ci = {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ] \qquad ( 6 )$$

is hereinafter referred to as the i'th component of the extension \hat{x} with i=1−L.

The calculation unit 120 comprises a frequency estimation unit 122 for determining a plurality of L×K phase coefficients θₖ^{l} with k=1−K for all components Ci with i=1−L of the extension \hat{x}(n) according to formula (5) representing the individually received segment x(n). Said plurality of L×K frequencies θₖ^{l} is input to a pattern generating unit 124 for calculating a plurality of L frequency parameters Θ^{l}(n) with i=1−L according to formula (5). Said pattern generating unit 124 is further adapted for generating a plurality of J×L pairs of patterns pᵢⱼ¹, pᵢⱼ², for the components Ci with i=1−L according to:

pᵢⱼ¹=fⱼ(n) cos (Θ^{l}(n)); and

pᵢⱼ²=fⱼ(n) sin (Θ(n))

for i=1−L and j=0−(J−1).

Said plurality of pairs of patterns pᵢⱼ¹, pᵢⱼ² is —together with the segment x(n)—input to an amplitude estimation unit 126 for determining a plurality of J×L amplitude data d_{J}ⁱ for all received patterns pᵢⱼ¹ and a plurality of J×L amplitude data e_{J}^{l} for all the received patterns pᵢⱼ² of all components Cᵢ of the extension \hat{x}(n).

The calculation unit 120 and in particular the frequency estimation unit 122 and the amplitude estimation unit 126 are adapted such that the sinusoidal data comprising the phase data θₖ^{l} and the amplitude data d_{J}^{l} and e_{J}^{l} is determined and optimised such that the criterion “minimisation of weighted squared error E between the segment x(n) and the extension \hat{x}(n)” is (approximately) fulfilled.

The parametric encoder 100 may further comprise a multiplexer 130 for transforming the plurality of L×K phase coefficients θₖ^{l} as output by said frequency estimation unit 122 and said plurality of J×L amplitude data dⱼ^{l} and e_{J}^{l} as output by said amplitude estimation unit 126 into a data stream to be stored on a storage medium or to be transmitted via a channel.

FIG. 2 shows a second embodiment of the parametric encoder 100′. Like the parametric encoder 100 the parametric encoder 100′ also serves for generating said sinusoidal code data from the input audio or speech signal s. The operation of its segmentation unit 110′ corresponds to the operation of the segmentation unit 110. Consequently, the segmentation unit 110′ generates segments x(n) of the received signal s at its output. Said segments x(n) are input to a calculation unit 120′. In difference to the first embodiment of the calculation unit 120 the calculation unit 120′ does not calculate the plurality of sinusoidal code data simultaneously for all components of a segment \hat{x}(n) but generates this sinusoidal code data sequentially for each component Ci with i=1−L of the extension \hat{x}. This way of calculation is generally known in the art as analysis-by-synthesis or as matching pursuit algorithm. However, in the prior art an application of said method is only known for extensions different from the claimed extension \hat{x} according to formula (4).

In the following the operation of said second embodiment of the calculation unit 120′ is explained by referring to FIGS. 2 and 3. More specifically, the calculation of the sinusoidal code data of the extension \hat{x} according to equation (4) is described such that the weighted squared error between a segment output by the segmentation unit 100′ and its extension \hat{x} according to equation (4) is (approximately) minimised.

In a first cycle i=1 the sinusoidal code data of a first component Ci with i=1 of the extension \hat{x} are calculated (method step a) in FIG. 3).

For achieving this, the output of segmentation unit 110′x(n) is set to: εᵢ₋₁=x(n) (see method step b)).

In said first cycle, said output of the segmentation unit 110′ is input to a frequency estimation unit 122′ for determining a plurality of K phase coefficients θₖ^{l} with k =1−K from the input value εᵢ₋₁ (see method step c)). Said phase coefficients θₖ^{l} represent the phases of the searched sinusoidal code data and are thus output from the calculation unit.

Moreover, said phase coefficients θₖ^{l} are input to a pattern generating unit 124′ for calculating the phase Θ^{l} with i=1 for the first component C1 according to equation (5) (see method step d)). Said pattern generating unit 124′ further serves for generating a plurality of 2×J patterns with j=0−(J−1) for the component Ci with:

pᵢⱼ¹=fⱼ(n) cos (Θ^{l}(n)); and

pᵢⱼ²=fⱼ(n) sin (Θ^{l}(n))

for i=1 (see method step e)). These generated patterns pᵢⱼ¹, pᵢⱼ² are −together with the parameter εᵢ₋₁ input to an amplitude estimation unit 126′. Said amplitude estimation unit 126′ serves for determining a plurality of J amplitudes d_{J}^{l} for said patterns pᵢⱼ^{l} and of J amplitudes e_{J}^{l} for said patterns pᵢⱼ² for the component Ci with i=1 from the received input data (see method step f)). Said calculated amplitudes d_{J}^{l} and e_{J}^{l} form the amplitude part of the sinusoidal data representing the extension \hat{x} of the segment x(n) and are thus output from that calculation unit 120′ in order to be—together with said phase data θₖ^{l} merged into a data stream representing said first component Ci with i=1. Moreover, said amplitude data d_{J}^{l} and e_{J}^{l} are—together with their respective patterns pᵢⱼ¹ and pᵢⱼ² input into a synthesiser 128′ for calculating the component Ci with i=1 according to

$${C}_{i} = {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$

(see method step g)).

Said component Ci is input into a substracting unit 129′ for being substracted from the value εᵢ₋₁ being input to said frequency estimation unit 122′. The difference occuring at the output of said substracting unit 129′ is referred to as εᵢ with i=1 (see method step h)).

Now the first cycle for calculating the first component C1 and its sinusoidal code data θₖ^{l}, d_{J}^{l}, and e_{J}^{l}, for the extension \hat{x} has been finished. Subsequently, the parameter i is compared with the total number L of components Ci of the segment \hat{x}(see method step i)). If i<L method steps c) to i) are repeated for i=i+1. In these cases the output from the segmentation unit 110′ for i≧1 is disconnected from the input of the frequency estimation unit 122′; instead, the input of said frequency estimation unit 122′ is connected to the output of said substracting unit 129′ for receiving the differences εᵢ. However, if i≧L the sinusoidal code data of all L components of the extension \hat{x} have been calculated and thus the calculation process carried out by the calculation unit 120′ has been finished for a particular segment \hat{x}. Subsequently, the whole procedure may be repeated for a subsequent segment of the input audio or speech signal.

FIG. 4 shows a parametric decoder 400 for reconstructing an approximation ŝ of an audio or speech signal s from received input data. These received input data correspond to data of a data stream after being transmitted or restored from a storage medium.

The parametric decoder 400 comprises a selecting unit 420 for selecting sinusoidal code data θₖ^{l}, d_{J}^{l} and e_{J}^{l} representing segments \hat{x} of the approximation ŝ of the audio and/or speech signal s from said received input data. The parametric decoder 400 further comprises a synthesiser 440 for reconstructing said segments \hat{x} from said received sinusoidal code data and a joining unit 460 for re-constructing the approximation ŝ by linking the re-constructed segment \hat{x}.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A parametric encoder (100, 100′) for encoding an audio or speech signal s into sinusoidal code data, comprising:
a segmentation unit (110, 110′) for segmenting said signal s into at least one segment x(n);
a calculation unit (120, 120′) for calculating said sinusoidal code data in the form of the phase and amplitude data of a given extension \hat{x}(n) from the segment x(n) such that the extension \hat{x}(n) approximates the segment x(n) as good as possible for a given criterion; characterised in that
the calculation unit (120, 120′) is adapted to calculate the sinusoidal code data θₖ^{l}, dⱼ^{l} and eⱼ^{l} for the following extension \hat{x}:
$$\begin{matrix}{x}^{⋒} = {\sum }_{i = 1}^{L} Ci = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ] \\ with \\ {Θ}^{i} ( n ) = {\sum }_{k = 1}^{K - 1} {θ}_{k}^{i} {n}^{k}\end{matrix}$$
wherein:

| | |
|---|---|
| i,j,k | represent parameters; |
| n | represents a discrete time parameter; |
| Ci | represents the i'th component of the extension \hat{x}; |
| θₖⁱ | represents the phase coefficient as one of said sinusoidal data |
| fⱼ | represents the jth instance out of the set of J linearly |
| | independent functions; |
| Θⁱ | is a phase; and |
| dⱼⁱ,eⱼⁱ | represent the linearly involved amplitude values of the |
| | components representing parts of said sinusoidal data. |

2. The parametric encoder according to claim 1, characterised in that fⱼ(n)=n^{j}.

3. The parametric encoder according to claim 1, characterised in that the calculation unit (120) comprises:
a frequency estimation unit (122) for determining a plurality of LxK phase coefficients θₖ^{l} with i=1−L and k=1−K for all components Ci of the extension \hat{x} (n) representing the received segment x(n);
a pattern generating unit (124) for calculating a plurality of L phases Θⁱ(n) with i=1−L from the phase coefficients θₖ^{l} according to:
$${Θ}^{i} ( n ) = {\sum }_{k = 1}^{K - 1} {θ}_{k}^{i} {n}^{k}$$
and for generating a plurality of J×L pairs of patterns pᵢⱼ¹, pᵢⱼ² for the components Ci with i=1−L according to:
pᵢⱼ¹=fⱼ(n) cos (Θⁱ(n)) and pᵢⱼ²(n) sin (Θⁱ(n))
for i=1−L and j=0−(J−1); and
an amplitude estimation unit (126) for determining a plurality of J×L amplitudes d_{J}^{l} for the patterns pᵢⱼ¹ and a plurality of J×L amplitudes e_{J}^{l} for the patterns pᵢⱼ² of all components Ci of the extension \hat{x}:
wherein the sinusoidal data θₖ^{l}, d_{J}^{l} and e_{J}^{l} is at least approximately optimised for the criterion that the weighted squared error E between the segment x and its extension \hat{x} is minimised.

4. The parametric encoder according to claim 1, characterised by a multiplexer (130) for merging said sinusoidal code data into a data stream.

5. The parametric encoder according to claim 1, characterised in that the calculation unit (120′) comprises:
a frequency estimation unit (122′) for determining a plurality of K phase coefficients θₖ^{l} with k=1−K for the component Ci from an input value εᵢ₋1; wherein for the first component C1 with i=1 the input value is set to ε₀=x(n);
a pattern generating unit (124′) for calculating the phases Θⁱ for the component Ci from said plurality of phase coefficients θₖ^{l} according to:
$${Θ}^{i} ( n ) = {\sum }_{k = 1}^{K} {θ}_{k}^{i} {n}^{k}$$
and for generating a plurality of 2×J patterns pᵢⱼ¹, pᵢⱼ² with j=1−J for the component Ci with:
pᵢⱼ¹=j(n) cos (Θⁱ(n)) and pᵢⱼ²=fj(n) cos (Θⁱ(n));
an amplitude estimation unit (126′) for determining a plurality of J amplitudes d_{J}¹ and of J amplitudes e_{J}^{l} for said patterns of the component Ci from the received segment x(n) and from the received plurality of patterns pᵢⱼ¹, pᵢⱼ²;
a synthesiser (128′) for re-constructing the component Ci from said plurality of 2×J patterns pᵢⱼ¹, pᵢⱼ² and form the plurality of amplitudes d_{J}^{l} and e_{J}^{l} according to:
$$Ci = {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
and
a substraction unit (129′) for substracting said component Ci form the input value εᵢ₋₁ in order to feed the resulting difference si as new input value forward to the input of the frequency estimation unit (122′) for calculating the sinusoidal code data representing the component Ci+1;
wherein the sinusoidal data θₖ^{l}, d_{J}^{l} and e_{J}^{l} is optimised for the criterion that the weighted squared error E between the segment x and the extension \hat{x} is minimised.

6. A parametric coding method for encoding an audio or speech signal s into sinusoidal code data, comprising the steps of:
segmenting the signal s into at least one segment x(n); and
calculating said sinusoidal code data in the form of phase and amplitude data of a given extension \hat{x} from the segment x(n) such that the extension \hat{x} approximates the segment x(n) as good as possible for a given criterion, characterised in that
the extension \hat{x} is defined to:
$${x}^{⋒} = {\sum }_{i = 1}^{L} Ci = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
$$with$$
$${Θ}^{i} ( n ) = {\sum }_{k = 1}^{K} {θ}_{k}^{i} {n}^{k}$$
wherein:

| | |
|---|---|
| i | represents a component Ci of the extension \hat{x} n); |
| j,k | represent parameters; |
| n | represents a discrete time parameter; |
| fⱼ | represents the jth instance out of the set of J linearly |
| | independent functions; |
| θₖⁱ | represents the phase coefficient as one of said sinusoidal date |
| Θⁱ | is a phase; and |
| dⱼⁱ,eⱼⁱ | represent the linearly involved amplitude values of the |
| | components representing parts of said sinusoidal data. |

7. The method according to claim 6, characterised in that fⱼ(n)=n^{j}.

8. The method according to claim 6, characterised in that the frequencies θ₁^{l} are defined by picking peak frequencies in the frequency domain of the extension \hat{x}.

9. The method according to claim 6, characterised in that for fulfilling the criterion that the weighted squared error between the segment x and the extension \hat{x} is minimized the definition of the optimal amplitudes d_{J}^{l} and e_{J}^{l} comprises the steps of:
determining a plurality of L×K phase coefficients θₖ^{l} with i=1−L and k=1 −K for all components Ci of the received segment x(n);
calculating a plurality of L phases Θⁱ(n) with i=1−L from the phase coefficients θₖ^{l} according to:
$${Θ}^{i} ( n ) = {\sum }_{k = 1}^{K} {θ}_{k}^{i} {n}^{k} ;$$
generating a plurality of J×L pairs of patterns pᵢⱼ¹, pᵢⱼ² for the components Ci with i=1−L according to:
pᵢⱼ¹=fⱼ(n) cos (Θⁱ(n)) and pᵢⱼ²=fⱼ(n) sin (Θⁱ(n)); and
determining a plurality of J×L amplitudes dⱼ^{l} and a plurality of J×L amplitudes eⱼ^{l} for all the pairs of patterns pᵢⱼ¹, pᵢⱼ² of all components Ci of the extension \hat{x}.

10. The method according to claim 6, characterised in that for fulfilling the criterion that the weighted squared error between the segment x and the extension \hat{x} is minimized the definition of the amplitudes d_{J}^{l} and e_{J}^{l} comprises the steps of:
a) setting i=1
b) εᵢ₋₁=ε₀=x(n);
c) determining a plurality of K phase coefficients θₖ^{l} with k=1−K for the component Ci from an input value εᵢ₋₁;
d) calculating the phases Θⁱ for the component Ci from said plurality of phase coefficients θₖⁱ according to:
$${Θ}^{i} ( n ) = {\sum }_{k = 1}^{K} {θ}_{k}^{i} {n}^{k}$$
e) generating a plurality of 2×J patterns pᵢⱼ¹, pᵢⱼ² with j=0−(J−1) for the component Ci with:
pᵢⱼ¹=fⱼ(n) cos (Θⁱ(n)) and pᵢⱼ²=fⱼ(n) sin (Θⁱ(n));
f) determining a plurality of J amplitudes d_{J}^{l} and of J amplitudes e_{J}^{l} for said patterns for the component Ci from the received segment x(n) and from the received plurality of patterns pᵢⱼ¹, pᵢⱼ²;
g) constructing the component Ci from said plurality of J pairs of patterns pij and from the plurality of amplitudes d_{J}^{l} and e_{J}ⁱ according to:
$$Ci = {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
h) substracting said component Ci from the input value εᵢ₋₁ in order to calculate a resulting difference εᵢ;
i) checking if i≧L wherein L represents a given number of components;
j) if i<L repeat the method steps by starting again from step c) with i=i+1; and
k) if i≧L the sinusoidal code data of all L components of the extension \hat{x} have been calculated and thus the process has finished.

11. A parametric decoder (400) for re-constructing an approximation ŝ of an audio or speech signal s from transmitted or restored code data, comprising:
a selecting unit (420) for selecting sinusoidal code data representing segments x of the approximation Ŝ from said received transmitted or restored code data;
a synthesiser (440) for re-constructing said segments \hat{x} from said received sinusoidal code data; and
a joining unit (460) for joining consecutive segments \hat{x} to form said approximation ŝ of the audio or speech signal s;
wherein the sinusoidal code data is a plurality of frequency and amplitude values for at least one component of said segment \hat{x};
characterised in that
the synthesiser is adapted to re-construct said segments \hat{x} from said sinusoidal code data according to the following formula:
$${x}^{⋒} = {\sum }_{i = 1}^{L} Ci = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
$$with$$
$${Θ}^{i} ( n ) = {\sum }_{k = 1}^{K} {θ}_{k}^{i} {n}^{k}$$
wherein:

| | |
|---|---|
| i | represents a component Ci of the extension \hat{x} (n); |
| j,k | represent parameters; |
| n | represents a discrete time parameter; |
| fⱼ | represents the jth instance out of the set of J linearly |
| | independent functions; |
| θₖⁱ | represents the phase coefficient value as one of said sinusoidal |
| | data |
| Θⁱ | is a phase; and |
| dⱼⁱ,eⱼⁱ | represent the linearly involved amplitude values of the |
| | components representing parts of said sinusoidal data. |

12. Decoding method for reconstructing an approximation ŝ of an audio or speech signal s from transmitted or restored code data, comprising the steps of selecting sinusoidal code data representing segments \hat{x} of the approximation ŝ from said received transmitted or restored code data;
re-constructing said segments \hat{x} from said received sinusoidal code data; and
joining consecutive segments \hat{x} together in order to form said approximation ŝ of the audio or speech signal s;
wherein the sinusoidal code data is a plurality of phase and amplitude values for at least one component of said segment \hat{x}, characterised in that
in said re-construction step the segments \hat{x} are re-constructed from said sinusoidal code data according to the following formula:
$${x}^{⋒} = {\sum }_{i = 1}^{L} Ci = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
$$with$$
$${Θ}^{i} ( n ) = {\sum }_{k = 1}^{K} {θ}_{k}^{i} {n}^{k}$$
wherein:

| | |
|---|---|
| i | represents a component Ci of the extension \hat{x} (n); |
| j,k | represent parameters; |
| n | represents a discrete time parameter; |
| fⱼ | represents the jth instance out of the set of J linearly |
| | independent functions; |
| θₖⁱ | represents the phase coefficient as one of said sinusoidal data |
| Θⁱ | is a phase; and |
| dⱼⁱ,eⱼⁱ | represent the linearly involved amplitude values of the |
| | components representing parts of said sinusoidal data. |

13. Data stream comprising sinusoidal code data representing segments \hat{x} of an approximation ŝ of an audio or speech signal, wherein the sinusoidal code data is a plurality of phase and amplitude values for at least one component of said segment \hat{x}, characterised in that the segment \hat{x} is defined to:
$${x}^{⋒} = {\sum }_{i = 1}^{L} Ci = {\sum }_{i = 1}^{L} {\sum }_{j = 0}^{J - 1} [ {d}_{j}^{i} {f}_{j} ( n ) cos ( {Θ}^{i} ( n ) ) + {e}_{j}^{i} {f}_{j} ( n ) sin ( {Θ}^{i} ( n ) ) ]$$
$$with$$
$${Θ}^{i} ( n ) = {\sum }_{k = 1}^{K} {θ}_{k}^{i} {n}^{k}$$
wherein:

| | |
|---|---|
| i | represents a component Ci ofthe extension \hat{x} (n); |
| j,k | represent parameters; |
| n | represents a discrete time parameter; |
| fⱼ | represents the jth instance out of the set of J linearly |
| | independent functions; |
| θₖⁱ | represents the phase coefficient as one of said sinusoidal data |
| Θⁱ | is a phase; and |
| dⱼⁱ,eⱼⁱ | represent the linearly involved amplitude values of the |
| | components representing parts of said sinusoidal data. |

14. Storage medium on which a data stream as claimed in claim 13 has been stored.
